(19) United States
(12) Patent Application Publication
(10) Pub. No.: US 2012/0242713 A1
(43) Pub. Date: Sep. 27, 2012

(54) ELECTRONIC DEVICE AND LIGHT EMITTING ELEMENT DRIVING CIRCUIT

(75) Inventors: Nozomi YAGI, Kawasaki (JP); Yukihiro Sato, Kawasaki (JP)

(73) Assignee: FUJITSU LIMITED, Kawasaki-shi (JP)

(21) Appl. No.: 13/416,723

(22) Filed: Mar. 9, 2012

(30) Foreign Application Priority Data
Mar. 25, 2011 (JP) 2011-068702

(51) Int. Cl. G09G 5/10; H05B 37/00

(52) U.S. Cl. 345/690; 315/320

(57) ABSTRACT

An electronic device includes a driver configured to drive light emitting elements under matrix control; a first electric current path to connect a first light emitting element to the driver, the first electric current path including parallel signal lines to connect a cathode of the first light emitting element to two or more terminals of the driver; a second electric current path to connect a second light emitting element to the driver, at least a portion of the second electric current path extending from a cathode of the second light emitting element sharing a common path with the first electric current path; and a backflow prevention element provided on the first electric current path and inserted between the cathode of the first light emitting element and the common path.

### CROSS REFERENCE TO RELATED APPLICATIONS

This application is based upon and claims the benefit of priority of the prior Japanese Patent Application No. 2011-068702 filed on Mar. 25, 2011, the entire contents of which are incorporated herein by references.

### FIELD

The embodiments discussed herein are related to an electronic device and light emitting element driving circuit.

### BACKGROUND

Today's cellular phones and mobile terminals are furnished with LED (light-emitting diode) decoration on the housing cases or keypads. A variety of LED illumination patterns or 7-segment LED display patterns can form a rich taste in design and enhance differentiation of products. The number of LEDs used in a cellular phone or mobile terminal continues to increase to produce more decorative atmosphere. To efficiently control a large number of LEDs, a dot matrix LED driver is suitably used.

A matrix control circuit with rows and columns allows as many LEDs as the number of pixels determined by the matrix to be mounted. The anode of an LED is connected to a column, and the cathode of the LED is connected to a row. Under application of a voltage to the LEDs on a column, a row is selected (turned ON) to connect a specific LED to the constant current circuit of the LED driver. A constant current flows through the selected LED.

FIG. 1 and FIG. 2 illustrate a typical configuration of connection of a matrix control circuit. In FIG. 1, LED1, LED2 and LED3, each including RGB elements, are connected to a 2×6 matrix LED driver. This LED driver can activate up to twelve elements using eight terminals.

In an LED matrix driver, the upper limit of the electric current level supplied to each of the rows R1-R6 is determined by the driving ability of the device. Many LED drivers employ time-division multiplexing to switch on and off the electric current supplied to the connected LEDs. In the example of FIG. 1, LED devices are connected to six rows R1-R6 (six channels), each of the LED devices are turned on in a 1/6 duty cycle (ON/OFF ratio) within the divided period of time.

With a conventional technique, the value of effective current flowing through an LED is not so high due to influence of time-division multiplexing, in addition to LSI power dissipation and the limitation of driving ability of the device due to miniaturization. Under these constrains, an expected level of LED luminance may not be achieved.

A technique for increasing the quantity of electric current flowing through an LED to change the luminance of light emission of a single LED in a stepwise manner is known (see, for example, Patent Document 1). Because this known technique is irrelevant to matrix control, it is unnecessary for this approach to consider the limitation to the driving current level in matrix control or influence on other LED devices. If the conventional technique designed for control of a single LED is applied as it is to multiple LED devices, then two switches are required for each of the LED devices.

### PRIOR ART DOCUMENT

Patent Document 1: Japanese Laid-Open Patent Publication No. 2003-69672

It is desired for a LED matrix controller/driver and electronic equipment using such a matrix controller/driver to independently control the luminance of each of light emitting diodes (LED) without much change in the circuit structure.

### SUMMARY

According to one aspect of the present disclosure, an electronic device includes a driver configured to drive light emitting elements under matrix control; a first electric current path to connect a first light emitting element to the driver, the first electric current path including parallel signal lines to connect a cathode of the first light emitting element to two or more terminals of the driver; a second electric current path to connect a second light emitting element to the driver, at least a portion of the second electric current path extending from a cathode of the second light emitting element sharing a common path with the first electric current path; and a backflow prevention element provided on the first electric current path and inserted between the cathode of the first light emitting element and the common path.

According to another aspect of the present disclosure, a light emitting element driving circuit includes a display in which a plurality of light emitting elements are arranged; and a driver to drive the light emitting elements. A first light emitting elements among the light emitting element is connected to the driver via a first electric current path, the first electric current path including parallel signal lines to connect a cathode of the first light emitting element to two or more terminals of the driver; a second light emitting element among the light emitting element is connected to the driver via a second electric current path, a cathode of the second light emitting element being connected to a node on one of the parallel signal lines of the first electric current path; and a backflow preventing diode is provided between the node and the cathode of the first light emitting element.

The object and advantages of the invention will be realized and attained by means of the elements and combinations particularly pointed out in the claims. It is to be understood that both the foregoing general description and the following detailed description are exemplary and explanatory and are not restrictive to the invention as claimed.

### BRIEF DESCRIPTION OF DRAWINGS

FIG. 1 illustrates a conventional LED matrix driver circuit;

FIG. 2 illustrates a connection matrix of the LED matrix driver circuit of FIG. 1;

FIG. 3 illustrates a configuration of an LED matrix driver circuit conceived during the process of creating the present embodiments;

FIG. 4 illustrates a connection matrix of the LED matrix driver circuit of FIG. 3;

FIG. 5 illustrates an example of LED matrix driver circuit according to Embodiment 1;

FIG. 6 illustrates a connection matrix of the LED matrix driver circuit of FIG. 5;

FIG. 7 is a timing chart of the LED matrix driver circuit of Embodiment 1;

FIG. 8 is a flowchart of driver control to turn on a single-luminance RGB LED element;

FIG. 9 is a flowchart of driver control to turn on a double-luminance RGB LED element;

FIG. 10 illustrates a basic structure of a 2×3 matrix LED driver circuit that forms a basis for Embodiment 2;

FIG. 11 illustrates a configuration of an LED matrix driver circuit conceived during the process of creating the arrangement of Embodiment 2;

FIG. 12 illustrates an example of the LED matrix driver circuit according to Embodiment 2;

FIG. 13 is a timing chart of the LED matrix driver circuit of Embodiment 2;

FIG. 14 illustrates an example of an LED matrix driver circuit according to Embodiment 3;

FIG. 15 is a timing chart of the LED matrix driver circuit of Embodiment 3; and

FIG. 16 illustrates a wireless communication device as an example of electronic equipment to which the LED matrix driver circuits of Embodiment 1 through Embodiment 3 are applied.

### DESCRIPTION OF EMBODIMENTS

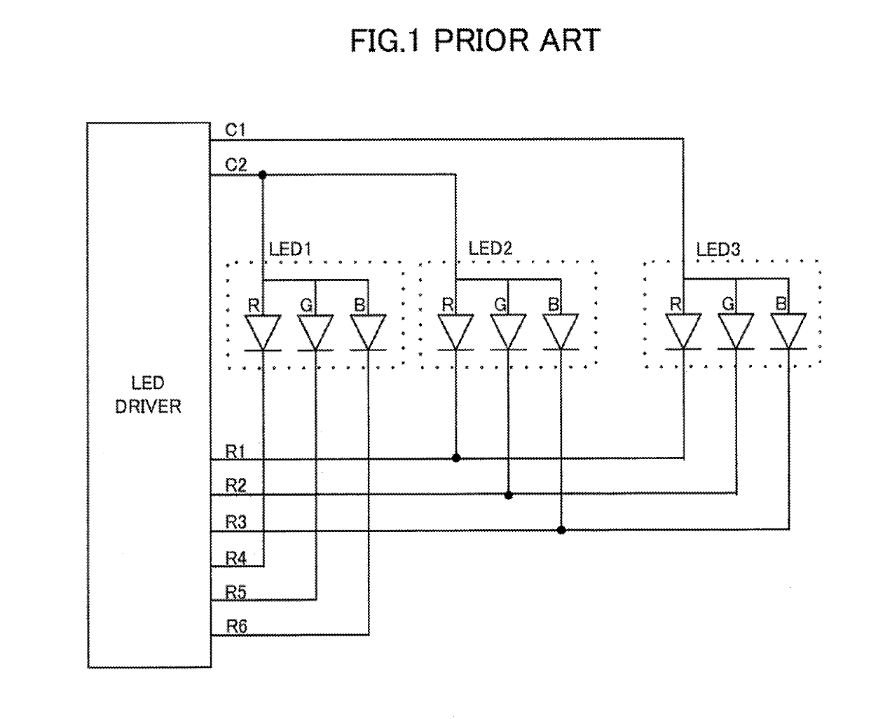

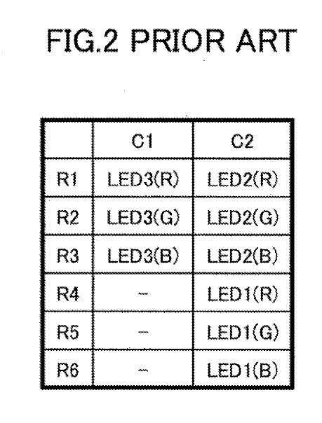

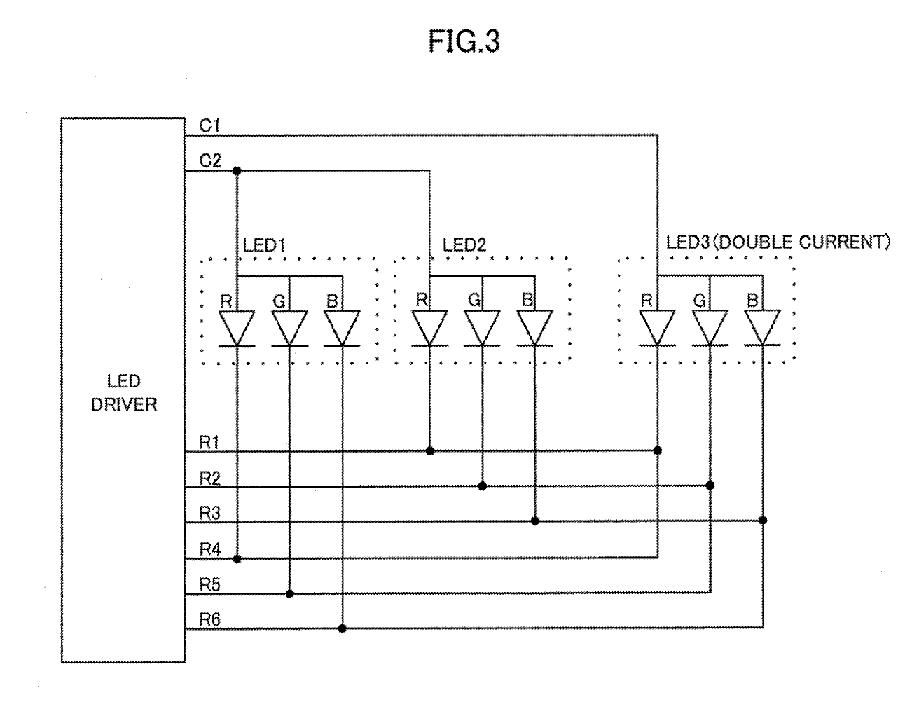

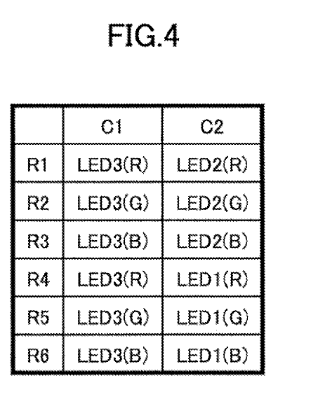

One approach to achieving high-luminance illumination using a time-division multiplexing LED matrix driver circuit illustrated in FIG. 1 and FIG. 2 is to make use of unconnected portions of the matrix (e.g., the rows R4, R5 and R6 connected to column D1) to supply more current to a specific RGB LED device (for instance, LED3 in FIG. 1). An example of configuration for supplying double current to LED3 is illustrated in FIG. 3 and FIG. 4.

In FIG. 3, LED3 includes RGB elements. The LED(R) element is connected to row R1 and row R4 in parallel. The LED(G) element is connected to row R2 and row R5 in parallel. The LED(B) element is connected to row R3 and row R6 in parallel. On the other hand, the RGB elements of LED1 are connected to R4, R5 and R6, respectively. Similarly, the RGB elements of LED2 are connected to R1, R2 and R3, respectively. Under this configuration, all of the matrix elements are used as illustrated in FIG. 4 and electric current is supplied to LED3 at 2/6 duty. Consequently, LED3 is perceived visually at double luminance level.

However, this configuration causes a short circuit between the cathode of LED1 and LED3 and between the cathode of LED2 and LED3. Accordingly, LED1 and LED2 cannot be controlled independently from each other. In addition, error operations will occur due to short circuit. Let's assume that it is intended to turn on R (red) element of LED2 and B (blue) element of LED3. In this case, short circuit between LED2-R element and LED3-B element causes unintended LED3-R element to light.

This technical issue is solved in the following embodiments. One or more light emitting elements are lighted at different luminance levels independently from the rest of the light emitting elements in electronic equipment using a driver circuit for regulating the lighting states under matrix control. In the specification and appended claims, “matrix control” is drive control for switching electric current supply to light emitting elements in a time-division multiplexing fashion using a number of terminals (or switches) less than the product of the number of rows and the number of columns.

To achieve this, a first light emitting element is connected to a driver via a first electric current path, in which the cathode of the first light emitting element is connected to two or more terminals or switches of the driver in parallel. A second light emitting element is connected to the driver via a second electric current path, a portion of the second electric current path sharing a common path with the first electric current path on the cathode side of the second light emitting device. A backflow prevention element is provided on the first electric current path between the cathode of the first light emitting element and the common path.

This configuration allows the first light emitting element and the second light emitting element to light independently from each other at different luminance levels. This configuration is applicable to either RGB multicolor display or monochromatic display. This configuration is capable of lighting a specific light emitting element at a luminance level of an integer multiple of that of the other light emitting elements.

### [a] First Embodiment

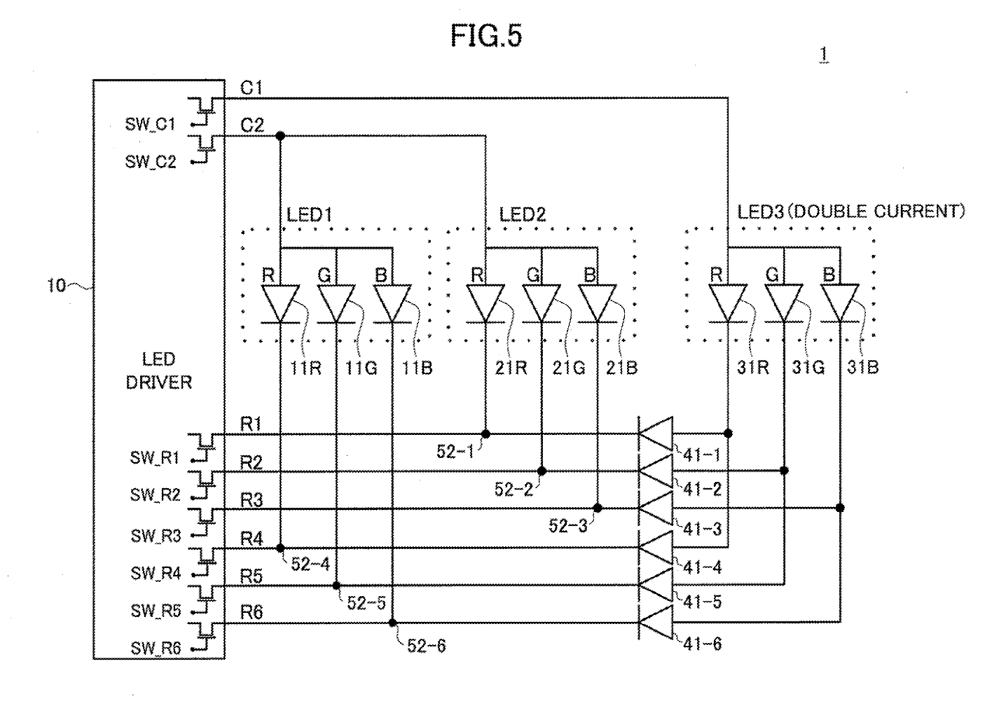

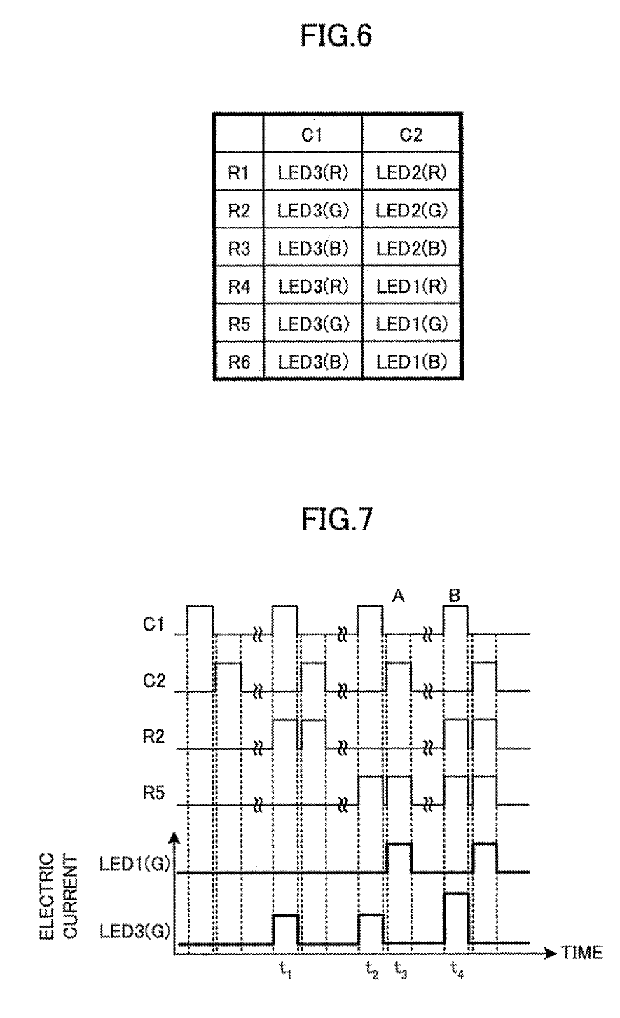

FIG. 5 illustrates an example of an LED matrix controller driver circuit 1 (referred to simply as “LED driver circuit 1”) according to the first embodiment. FIG. 6 illustrates a connection matrix of the LED driver circuit 1 of FIG. 5. The LED driver circuit 1 includes RGB LED (light emitting diode) devices LED1, LED2 and LED3. Each of the RGB LED devices LED1-LED3 includes LED elements corresponding to R (red), G (green) and B (blue). The LED elements are connected to prescribed terminals of the LED driver 10.

The LED driver 10 has multiple switches for selecting rows and columns. To be more precise, two switches SW_C1 and SW_C2 for selecting columns, and six switches SW_R1 through SW_R6 for selecting rows are provided to form a 2×6 matrix. By switching on the SW_C1 and SW_C2, electric voltage is applied to the respective columns. By selecting (switching on) an arbitrary one of SW_R1 through SW_R6, electric current is drawn to the selected row by the constant current circuit (not illustrated) connected in the LED driver 10. Electric current flows from the anode to the cathode of a selected LED element, thereby lighting the selected LED element.

LED1 includes three LED elements 11R, 11G and 11B. The anodes of the LED elements 11R, 11G and 11B are connected to column C2. The cathodes of the LED elements 11R, 11G and 11B are connected to the associated rows R4, R5 and R6 via nodes 52-4, 52-5 and 52-6, respectively.

LED2 includes three LED elements 21R, 21G and 21B. The anodes of the LED elements 21R, 21G and 21B are connected to column C2. The cathodes of the LED elements 21R, 21G and 21B are connected to the associated rows R1, R2 and R3 via nodes 52-1, 52-2 and 52-3, respectively.

LED3 includes three LED elements 31R, 31G and 31B. The anodes of the LED elements 31R, 31G and 31B are connected to column C1. The cathode of the LED element 31R is connected to the switches SW_R1 and SW_R4 in parallel corresponding to rows R1 and R4. The cathode of the LED element 31G is connected to the switches SW_R2 and SW_R5 in parallel corresponding to rows R2 and R5. The cathode of the LED element 31B is connected to the switches SW_R3 and SW_R6 in parallel corresponding to rows R3 and R6.

FIG. 6 illustrates in a plain way the 2×6 matrix connection. The connection matrix of FIG. 6 is similar to that of FIG. 4. Each of the LED elements 31R, 31G and 31B (corresponding to LED3(R), LED3(G) and LED3(B) in FIG. 6) in column C1 is connected to two rows to take double current in the element within a period, compared with the other elements in LED1 and LED2.

A difference from the configuration of FIG. 3 and FIG. 4 is that backflow prevention diodes 41-1 through 41-6 are inserted on the cathode sides of the LED elements 31R, 31G and 31B of LED3. This configuration is described in more detail below.

A signal line connecting the LED element 31R of LED3 to the column switch SW_C1 of the LED driver 10 and a signal line connecting the LED element 31R to the row switch SW_R1 are included in a first electric path. On the other hand, a signal line connecting the LED element 21R of LED2 to the column switch SW_C2 of the LED driver 10 and a signal line connecting the LED element 21R to the row switch SW_R1 form a second electric path. The first electric current path and the second electric current path overlap each other between the switch SW_R1 and the node 52-1, and the overlapped portion forms a common path. A backflow prevention diode 41-1 is inserted between the common path on row R1 and the cathode of the LED element 31R of LED 3.

Similarly, a signal line connecting the LED element 11R of LED 1 to the column switch SW_C2 of the LED driver 10 and a signal line connecting the LED element 11R to the row switch SW_R4 form a second electric path. This second electric current path overlaps the first electric current path between the switch SW_R4 and the node 52-4, and the overlapped portion forms a common path. A backflow prevention diode 41-4 is inserted between the common path on row R4 and the cathode of the LED element 31R of LED3.

The configuration is employed between the LED element 31G and the LED elements 11G and 21G, and between the LED element 31B and the LED elements 11B and 21B. Backflow prevention diodes 41-2 and 41-5 are inserted between the cathode of the LED element 31G and the common paths on rows R2 and R5, respectively. Backflow prevention diodes 41-3 and 41-6 are inserted between the cathode of the LED element 31B and the common paths on rows R3 and R6.

Inserting a backflow prevention diode between a predetermined LED element and the associated common path can prevent an unintended LED element from lighting. For example when the LED element 21R of LED2 and the LED element 31G of LED3 are selected simultaneously, unselected LED element 31R can be maintained in the unlighted state.

FIG. 7 is a timing chart of drive control carried out by the LED driver 10 of FIG. 5. The horizontal axis indicates time, and the vertical axis indicates electric current level. As has been explained above, electric current is drawn when a column switch and a row switch are turned on, and the corresponding LED element defined by the selected column and row is lighted. FIG. 7 illustrates switch-ON timing of only C1, C2, R2, R4 for the sake of convenience, but all the row switches R1-R6 are subjected to the ON/OFF control in the actual operation.

In mode A at time (or period) t3, switch SW_C2 connected to column C2 and switch SW_R5 connected to row R5 (see FIG. 5) are turned on, and the LED element 11G of LED1 (labeled as LED1(G) in FIG. 7) lights. Since six rows are switched over in a time division multiplexing fashion within a period, the ON ratio of LED1(G) (i.e., the LED element 11G) is 1/6. Accordingly, one sixth of the full current at period t3 flows in LED1(G).

In mode B at time (or period) t4, column C1 and rows R2 and R5 are selected. Accordingly, switches SW_C1, SW_R2 and SW_R5 are turned on and the LED element 31G of LED3 (labeled as LED3(G) in FIG. 7) lights. In this case, the constant current circuit (not shown) of the LED driver 10 draws electric current via two parallel lines of R2 and R5, and the duty become 2/6. Consequently, double current flows through LED element 31G compared with mode A.

It should be noted that the LED element 31G of LED3 does not always light at double luminance compared with the other LED elements. At timings (periods) t1 and t2, either one of R2 or R5 is selected, while applying a voltage to column C1, and the LED element 31G lights at a base level of luminance (single luminance). This arrangement allows the degree of freedom of designing lighting patterns to increase and decorativity is enhanced.

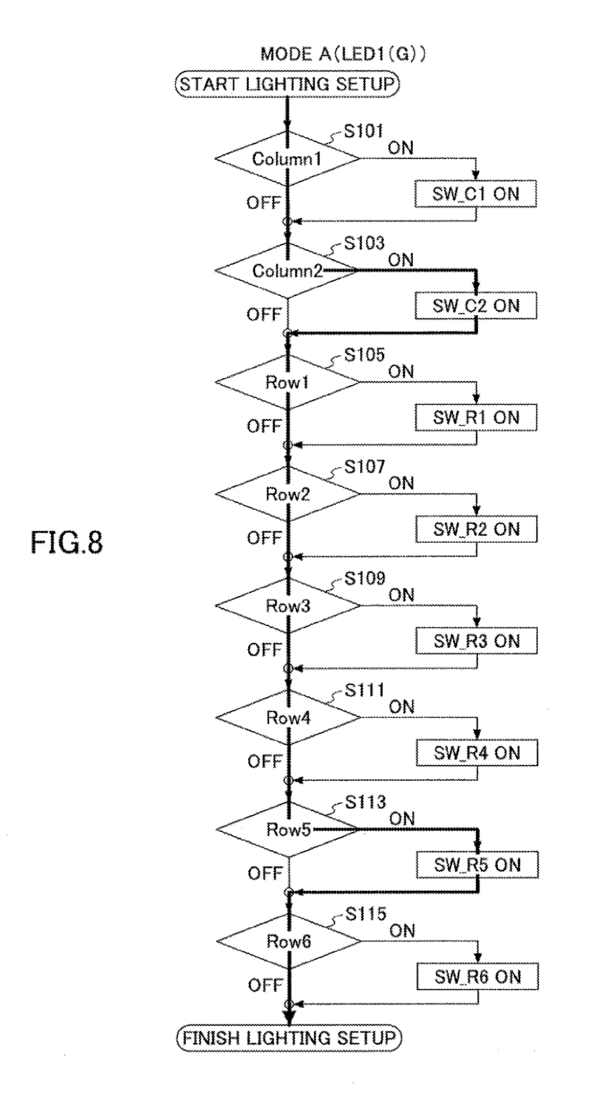

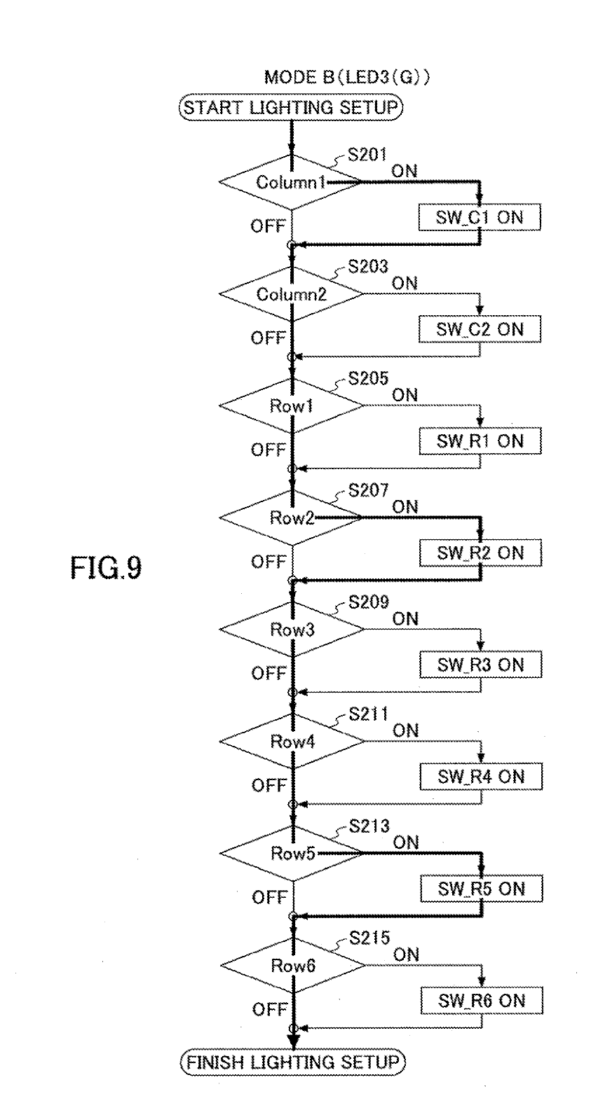

FIG. 8 illustrates a control flow performed on the respective switches in mode A at t3 in FIG. 7, and FIG. 9 illustrates a control flow in mode B at time 4 in FIG. 7. The procedures of the control flows are stored in a driver IC included in the LED driver 10.

In FIG. 8, to create mode A, it is determined for each of the columns (C1, C2) and rows (R1-R6) whether to turn on the corresponding switch. In mode A, column C2 and row R5 are turned on to light the green LED element 11G of LED1 at base luminance. Accordingly, it is determined through ON/OFF determination for column C2 (S103) and row R5 (S113) to turn on switches SW_C2 and SW_R5. On the other hand, it is determined through ON/OFF determination for column C1 (S101) and rows R1, R2, R3, R4 and R6 (S105, S107, S109, S111 and S115) to maintained the corresponding switches in the OFF state. The determination of S101 through S115 may be performed simultaneously, in place of serial determination.

When electric current flows through the LED element 11G of LED1 at time t3, the operation of LED3(G) is not affected even if column C1 is switched on because the backflow prevention diode 41-5 is inserted between the cathode of the LED element 11G (or the node 52-5) and the cathode of the LED element 31G of LED3.

In FIG. 9, to create mode B, it is determined for each of the columns (C1, C2) and rows (R1-R6) whether to turn on the corresponding switch. In mode B, column C2 and rows R2 and R5 are turned on to light the green LED element 31G of LED3 at double luminance. Accordingly, it is determined through ON/OFF determination for column C1 (S201) and rows R2 and R5 (S207 and S213) to turn on switches SW_C1, SW_R2 and SW_R5. On the other hand, it is determined through ON/OFF determination for column C2 (S203) and rows R1, R3, R4 and R6 (S203, S205, S209, S211 and S215) to maintain the corresponding switches in the OFF state. The determination of S201 through S215 may be performed simultaneously, in place of serial determination.

The structure and the operations of the LED driver circuit can compensate for the limit on electric current flow in the matrix driver, and extend the dynamic range of the luminous intensity of LEDs.

### [b] Second Embodiment

In the first embodiment, explanation has been made of brightness control on a RGB multicolor display. The arrangement described above can be available for brightness control on monochromatic display applications. In the second embodiment, brightness control on the simplest configuration matrix circuit is explained below.

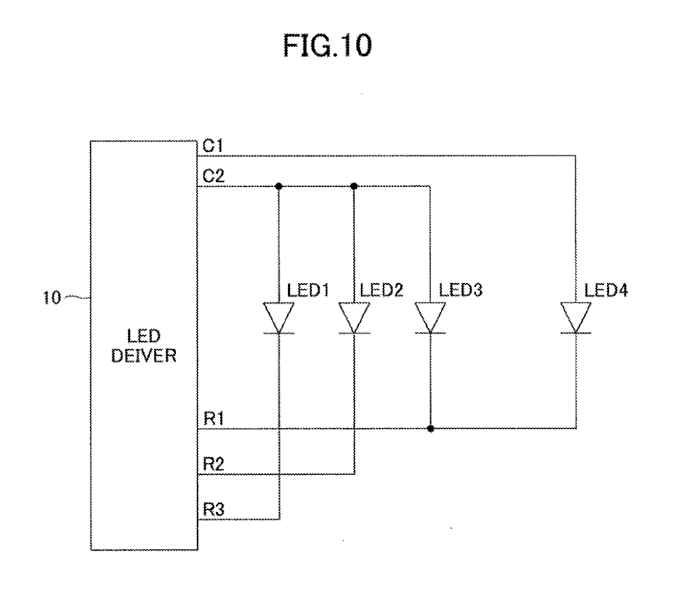

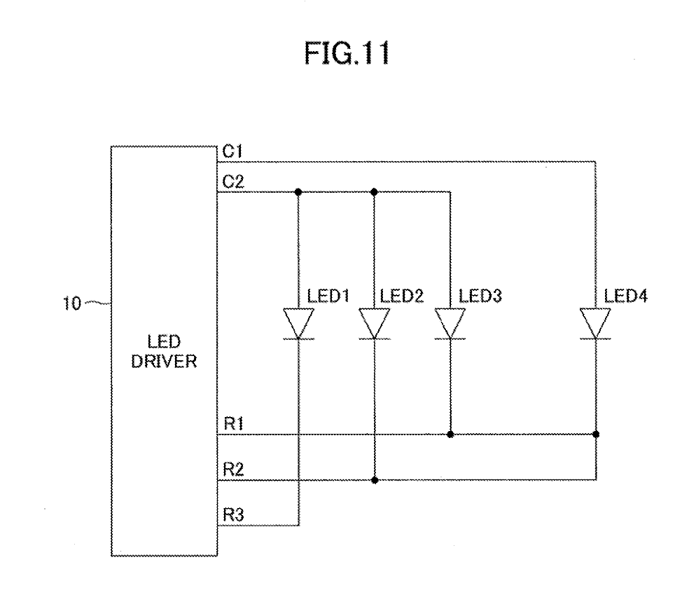

FIG. 10 illustrates a 2×3 matrix driver formed by two columns and three rows, in which four LEDs are connected. This matrix driver allows up to six LEDs to be connected using five switches. In FIG. 10, when an appropriate pair of switches (not shown) are turned on, electric current I flows through corresponding one of LED1 through LED4. To supply double current to LED4, the unused portion of the matrix, that is, connection between C1 and R2 or between C1 and R3 can be used.

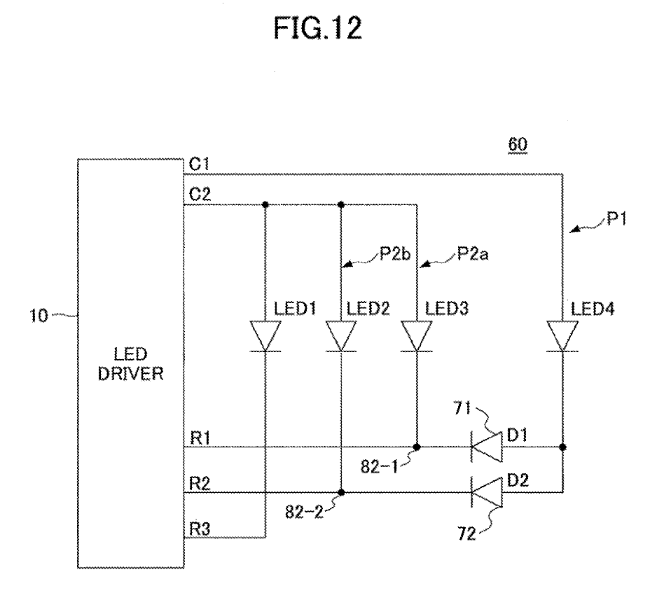

In FIG. 11, row R2 is used to connect the cathode of LED4 to R1 and R2 in parallel. When switches (not shown) corresponding to C1, R1 and R2 are turned on, double current 21 can be supplied to LED 4. However, with this circuit, LED3 and LED4 cannot be controlled independently from each other when LED3 is selected (that is, when column C2 and row R1 are selected) because LED3 and LED4 short on the cathode side. To solve this issue, the configuration of FIG. 12 was conceived.

FIG. 12 illustrates an example of an LED matrix controller driver circuit 60 (referred to simply as “LED driver circuit 60”) according to the second embodiment. The LED driver 10 of the LED driver circuit 60 has a set of terminals or switches (not shown) connected to columns C1 and C2, and a set of terminals or switches (not shown) connected to rows R1, R2 and R3.

Upon application of a voltage on a column, electric current supply is switched among three rows in a time-division multiplexing fashion. Accordingly, LED1, LED2 and LED3 are turned on at 1/3 duty. On the other hand, the duty of LED4 which is connected in parallel to R1 and R2 is 2/3.

LED4 which is designed to operate at high intensity is connected to the LED driver 10 via the first electric current path P1. The cathode of LED4 is connected to R1 and R2 in parallel.

LED3 is connected to the LED driver 10 via the second electric current path P2a. The cathode of LED3 is connected via the node 82-1 to R1, which row is a portion of the first electric current path P1 of LED4. In other words, the second electric current path P2a includes a common path shared with the first electric current path P1 on the cathode side of LED3. A backflow prevention diode 71 is inserted between the common path and the cathode of LED4.

Similarly, LED2 is connected to the LED driver 10 via the second electric current path P2b. The cathode of LED2 is connected via the node 82-2 to R2, which row is a portion of the first electric current path P1 of LED4. In other words, the second electric current path P2b includes a common path shared with the first electric current path P1 on the cathode side of LED2. A backflow prevention diode 72 is inserted between the common path and the cathode of LED4.

The configuration of FIG. 12 can prevent electric current from flowing to the cathode of LED4 when LED3 or LED2 is turned on.

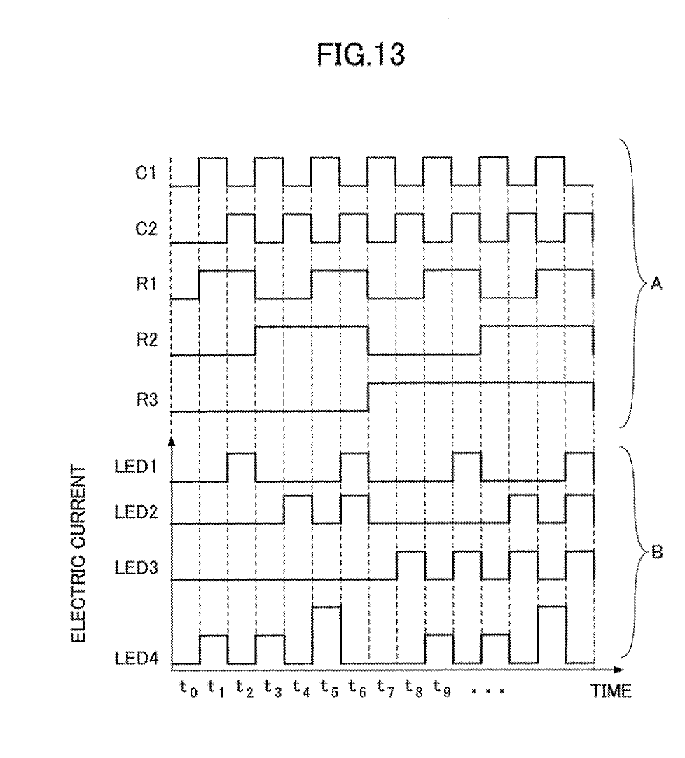

FIG. 13 is a timing chart of drive control performed by the LED driver circuit 60 according to the second embodiment. Columns C1 and C2 are turned on and off at alternate cycles. Rows R1, R2 and R3 are turned on and off at prescribed timings. By controlling the ON/OFF timing of the columns C1 and C2 and the rows R1, R2 and R3 as illustrated in the top part A of FIG. 13, the quantity and timing of electric current flow through LED1, LED2, LED3 and LED4 are determined as illustrated in the bottom part B of FIG. 13.

Focusing on LED4, column C1 and row R1 are selected at t1 and LED4 lights at a base level of luminance (single luminance). At t3, column C1 and row R2 are selected and LED4 lights at the base level of luminance. At t5, column C1 and rows R1 and R2 are selected and LED4 lights at double luminance. The brightness control of FIG. 13 extends the dynamic range of emission of light, and a wide variety of lighting patterns can be provided.

### [c] Third Embodiment

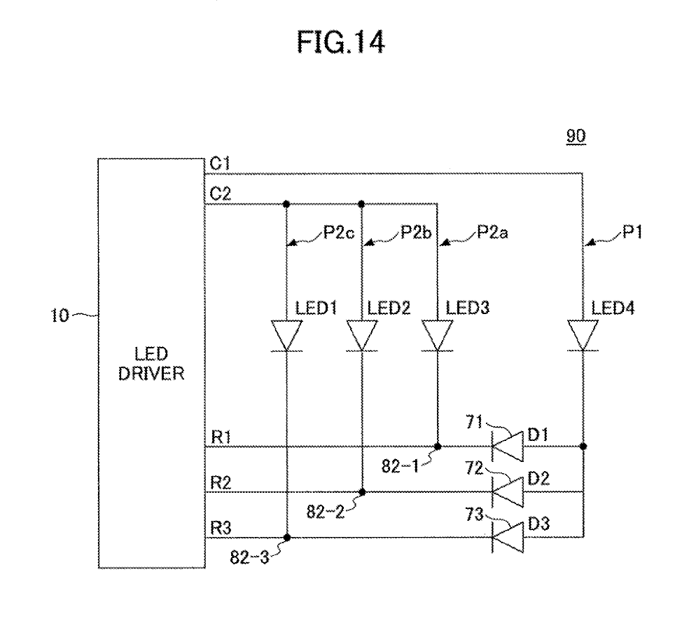

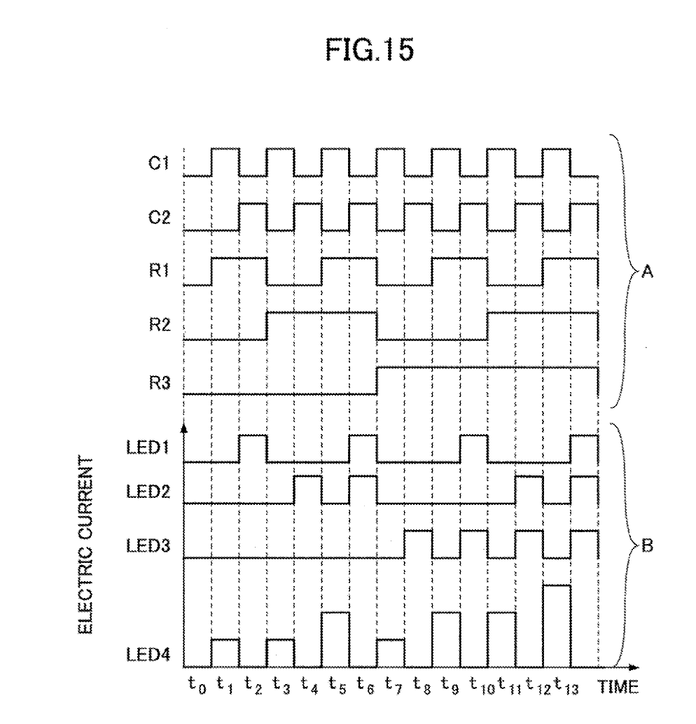

FIG. 14 and FIG. 15 illustrate an example of LED matrix controller driver circuit 90 (referred to simply as “LED driver circuit 90”) according to the third embodiment. The LED driver 10 of the LED driver circuit 90 includes a set of switches (not shown) connected to columns C1 and C2 and a set of switches (not shown) connected to rows R1, R2 and R3, similar to the second embodiment. In the third embodiment, LED 4 is lighted at triple luminance.

Upon application of a voltage on a column, electric current supply is switched among three rows in a time-division multiplexing fashion. Accordingly, LED1, LED2 and LED3 are turned on at 1/3 duty. On the other hand, the cathode of LED4 is connected to R1, R2 and R3 in parallel, and the duty becomes 3/3. A signal line connecting the anode of LED4 to the LED driver 10 (or column C1) and three signal lines connecting the cathode of LED4 to the LED driver 10 in parallel along R1, R2 and R3 are included in a first electric current path P1.

LED3 is connected to the LED driver 10 via the second electric current path P2a. The cathode of LED3 is connected via the node 82-1 to R1, which row is a portion of the first electric current path P1 of LED4. In other words, the second electric current path P2a includes a common path on R1 shared with the first electric current path P1 on the cathode side of LED3. A backflow prevention diode 71 is inserted between the common path on R1 and the cathode of LED4.

LED2 is connected to the LED driver 10 via the second electric current path P2b. The cathode of LED2 is connected via the node 82-2 to R2, which row is a portion of the first electric current path P1 of LED4. In other words, the second electric current path P2b includes a common path on R2 shared with the first electric current path P1 on the cathode side of LED2. A backflow prevention diode 72 is inserted between the common path on R2 and the cathode of LED4.

LED1 is connected to the LED driver 10 via the second electric current path P2c. The cathode of LED1 is connected via the node 82-3 to R3, which row is a portion of the first electric current path P1 of LED4. In other words, the second electric current path P2c includes a common path on R3 shared with the first electric current path P1 on the cathode side of LED1. A backflow prevention diode 73 is inserted between the common path on R3 and the cathode of LED4.

The configuration of FIG. 14 can prevent electric current from flowing to the cathode of LED4 even when any one of the LED1 through LED3 is turned on.

FIG. 15 is a timing chart of drive control performed by the LED driver circuit 90 according to the third embodiment. Columns C1 and C2 are turned on and off at alternate cycles. Rows R1, R2 and R3 are turned on and off at prescribed timings. By controlling the ON/OFF timing of the columns C1 and C2 and the rows R1, R2 and R3 as illustrated in the top part A of FIG. 15, the quantity and timing of electric current flow through LED1, LED2, LED3 and LED4 are determined as illustrated in the bottom part B of FIG. 15.

Focusing on LED4, column C1 and one of rows R1-R3 are selected at t1 and t3, and LED4 lights at a base level of luminance (single luminance). At t5, column C1 and rows R1 and R2 are selected and LED4 lights at double luminance. At t13, column C1 and all the rows R1-R3 are selected, and LED4 lights at triple luminance. The brightness control of FIG. 15 extends the dynamic range of emission of light, and a wider variety of lighting patterns can be provided.

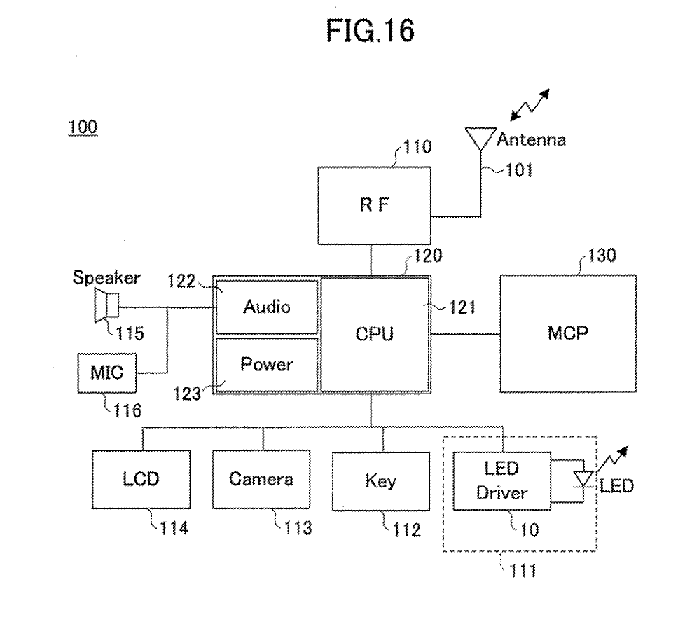

FIG. 16 is schematic diagram illustrating a structure of a wireless communication terminal 100, which is an example of electronic equipment to which the LED driver circuit of the first through third embodiments are applied. The wireless communication terminal 100 includes an antenna 101, a radio-frequency (RF) processor 110, an ASIC (application specific integrated circuit) 120, and an MCP (modulation coding processor) 130. The ASIC 120 includes a CPU (central processing unit) 121, an audio processor 122, a power source processor 123, and other components (not shown). These components are mounted on a LSI (large-scale integration) substrate. Input and output devices such as an LED display 11 including the LED driver 10, a keyboard 112, a camera 113, a LCD (liquid crystal display) 114, a speaker 115, or microphone 116, are connected.

A signal received at the antenna 101 is amplified at the RF processor 110, subjected to analog-to-digital conversion, and downconverted to a baseband frequency. The baseband digital signal is subjected to digital signal processing at the CPU 121, and further subjected to demodulation and decoding at MCP 130. The demodulated and decoded signal is subjected to error correction at the CPU 121. If audio components are contained in the received signal, the audio components are subjected to audio processing at the audio processor 122. The processed signals are output to the speaker 115 and the LCD 114.

The LED display 111 includes an LED driver 10. The LED display 111 may use any one of the LED driver circuits of the first through third embodiments. The LED display 111 has multiple LED elements. The LED elements can be arranged on any locations, such as on the surface of the housing case of the wireless communication terminal 100 or an operations panel having the keyboard 112. The LED display 111 displays various patterns by lighting the LED elements and changing the brightness or the intensity of the LED elements in multiple steps upon reception of electronic mail or a voice call, when displaying a time, or upon completion of battery charge.

Although the embodiments have been described using light emitting diodes (LEDs) as an example of light emitting elements, the disclosures are not limited to this example. Arbitrary devices that emit light in response to electric current flow may be used in the driver circuit of the first through third embodiments. Such devices include EL (electroluminescence) devices, inorganic EL devices, light-emitting transistors, and any other suitable devices.

Any types of switches may be used as the switches of the driver circuit. For example, transistors (bipolar transistors or MOS transistors), diodes (PN diodes, PIN diodes, Schottky diodes, MIM (metal insulator metal) diodes, or MIS (metal insulator semiconductor) diodes), or a logic circuit with any combinations of switches can be used.

The LED matrix driver circuit of the first through third embodiments can be applied not only to electronic equipment such as a cellular phone, but also to ornamental or decorative electronic devices used at arbitrary locations such as stores, streets, entryways, or houses.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present inventions have been described in detail, it should be understood that the various changes, substitutions, and alterations could be made hereto without departing from the spirit and scope of the invention.

What is claimed is:

1. An electronic device comprising:
a driver configured to drive light emitting elements under matrix control;
a first electric current path to connect a first light emitting element to the driver, the first electric current path including parallel signal lines to connect a cathode of the first light emitting element to two or more terminals of the driver;
a second electric current path to connect a second light emitting element to the driver, at least a portion of the second electric current path extending from a cathode of the second light emitting element sharing a common path with the first electric current path; and
a backflow prevention element provided on the first electric current path and inserted between the cathode of the first light emitting element and the common path.

2. The electronic device according to claim 1, wherein the cathode of the second light emitting element is connected to one of the parallel signal lines of the first electric current path at a node, and
The common path extends between the node and the terminal of the driver to which the node is connected.

3. The electronic device according to claim 1, wherein the cathode of the first light emitting element is connected to two or more row-selecting switches of the driver, and
The cathode of the second light emitting element is connected to one of the two or more row-selecting switches.

4. The electronic device according to claim 3, wherein the anode of the first light emitting element is connected to a first column-selecting switch of the driver, and
The anode of the second light emitting element is connected to a second column-selecting switch of the driver.

5. A light emitting element driving circuit comprising:
a display in which a plurality of light emitting elements are arranged; and
a driver to drive the light emitting elements,
wherein a first light emitting element among the light emitting elements is connected to the driver via a first electric current path, the first electric current path including parallel signal lines to connect a cathode of the first light emitting element to two or more terminals of the driver, and
a second light emitting element among the light emitting elements is connected to the driver via a second electric current path, a cathode of the second light emitting element being connected to a node on one of the parallel signal lines of the first electric current path, and
a backflow preventing diode is provided between the node and the cathode of the first light emitting element.
